(19) United States
(12) Patent Application Publication
(10) Pub. No.: US 2006/0161822 A1
(43) Pub. Date: Jul. 20, 2006

(54) Method and apparatus for compressing error information, and computer product

(75) Inventor: Daitarou Furuta, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/117,314

(22) Filed: Apr. 29, 2005

(30) Foreign Application Priority Data
Jan. 19, 2005 (JP) 2005-011919

(51) Int. Cl. G06F 11/00

(52) U.S. Cl. 714/52

(57) ABSTRACT

An error-information compressing apparatus acquires a hardware error from a hardware, stores reference data in a storing unit, compresses the hardware error by using the reference data into compressed hardware error, and writes the compressed hardware error in a storage device. The hardware error is compressed by calculating a difference between the hardware error acquired and the reference data. If the volume of the compressed hardware error is larger than the original hardware error, the reference data is updated with the compressed hardware error.

### BACKGROUND OF THE INVENTION

1) Field of the Invention

The present invention relates to a technology for compressing a hardware error acquired and storing the compressed hardware error.

2) Description of the Related Art

An error-information collecting firmware (hereinafter, “firmware”) is known that accumulates hardware errors, which are errors occurring in processors and memories of a server apparatus, and causes a storage device to store the hardware errors. The firmware can store the hardware error without an operating system. In other words, firmware can accumulate and store hardware errors that have occurred even when the operating system is not yet started such as the time of starting the server apparatus.

Japanese Patent Application Laid-Open Publication No. H10-232815 discloses a communication terminal apparatus that can prevent acquisition of duplicate data by comparing existing data with newly acquired data.

However, the storage device generally employs a nonvolatile memory to carry out an ex-post error analysis, and there is a limit to a capacity of the storage device. Therefore, when using the conventional firmware, due to the limit to the capacity of the storage device, all the hardware error can not be collected if the number of hardware errors is large.

One approach is to deliver error data acquired by the error-information collecting firmware to an application program running on the operating system, compress the error data, and store the compressed error data in the storage device. However, if the operating system is used to compress the error data, heavy load is put on the operating system so that collection of the error data may not be carried out smoothly. Moreover, when the operating system is not yet started, such as a time of starting the server apparatus, the compression of the error data itself cannot be carried out.

Furthermore, the technology disclosed in Japanese Patent Application Laid-Open Publication No. H10-232815 relates to an application running on the operating system, and therefore, it cannot be used for an error-information collecting process required to carry out before starting the operating system. Even though one applies the technology disclosed in Japanese Patent Application Laid-Open Publication No. H10-232815, because there is a limit to a resource that can be used by a hardware-error-information collecting firmware, it is difficult to carry out such a complicated data processing that is carried out in the technology disclosed in Japanese Patent Application Laid-Open Publication No. H10-232815.

### SUMMARY OF THE INVENTION

It is an object of the present invention to at least solve the problems in the conventional technology.

According to an aspect of the present invention, an error-information compressing apparatus includes an acquiring unit that acquires a hardware error from a hardware; a storing unit that stores therein reference data; a compressing unit that compresses the hardware error by using the reference data into compressed hardware error; and a writing unit that writes the compressed hardware error in a storage device.

According to another aspect of the present invention, an error-information compressing method includes compressing a hardware error acquired from a hardware by using reference data into compressed hardware error; and writing the compressed hardware error in a storage device.

According to still another aspect of the present invention, a computer-readable recording medium that stores therein a computer program that causes a computer to implement the -above method.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic diagram for explaining a concept of an error-information compression processing according to conventional technology;

FIG. 2 is a schematic diagram for explaining a concept of an error-information compression processing according to the present invention;

FIG. 3 is a schematic diagram for explaining how hardware errors are acquired;

FIG. 4 is a schematic diagram for illustrating an example of an error record to be stored in a buffer;

FIG. 5 is a diagram for illustrating an example of an actual data of the error record;

FIG. 6 is a functional block diagram of an error-information compressing apparatus an embodiment of the present invention;

FIG. 7 is a schematic diagram for explaining an outline of a compression processing performed by the error-information compressing apparatus shown in FIG. 6;

FIG. 8 is a schematic diagram for illustrating an error record to be stored in a nonvolatile memory;

FIG. 9 is a flowchart of a process procedure for an error-information compression processing performed by the error-information compressing apparatus shown in FIG. 6; and

FIG. 10 is a schematic diagram for illustrating a relation between an error-information compressing program and a hardware.

### DETAILED DESCRIPTION

Exemplary embodiments of the present invention will be explained in detail below with reference to the accompanying drawings.

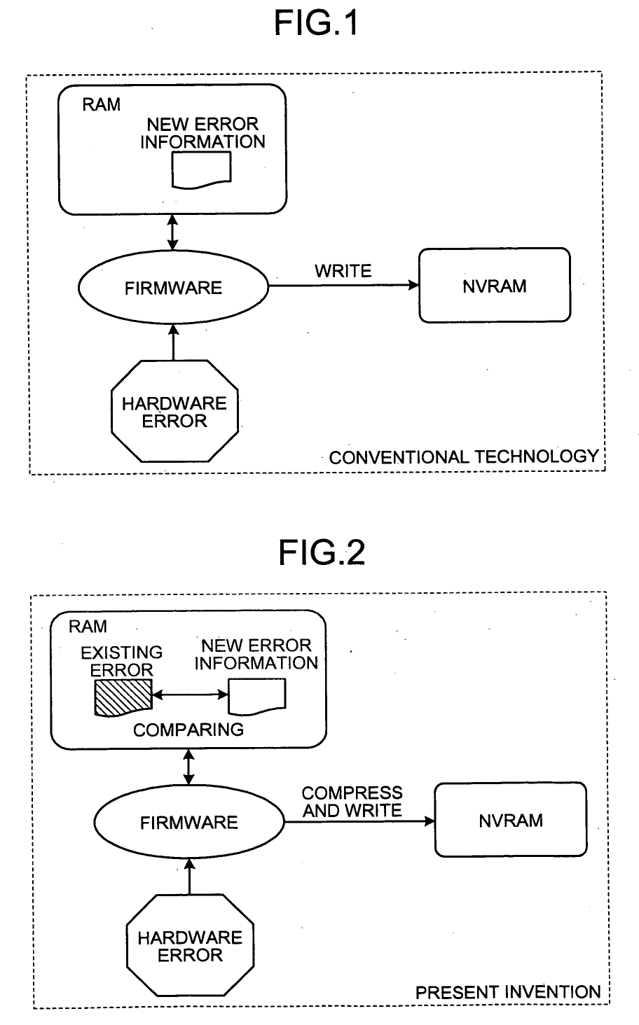

FIG. 1 is a schematic diagram for explaining a concept of an error-information compression processing according to conventional technology. FIG. 2 is a schematic diagram for explaining a concept of an error-information compression processing according to the present invention. The firmware shown in FIGS. 1 and 2 are computer programs stored in advance in a read only memory (ROM) of a server apparatus (not shown) and the like. When the server apparatus is started (booted), the firmware is loaded on a central processing unit (CPU), and the firmware carries out an error check of a variety of hardwares constituting the server apparatus and stores error data acquired. The error data is used later for specifying a unit at which an error has occurred.

Upon acquiring hardware error data, the conventional firmware generates error information by arranging a style of the error data detected on a buffer of a random access memory (RAM), and sequentially writes, as shown in FIG. 1, the error information generated in a nonvolatile memory such as a nonvolatile random access memory (NVRAM).

In this manner, the conventional firmware writes the hardware error data in the NVRAM without compressing the data. However, the typical server apparatuses available at this time generally use a large number of CPUs and memories, and accordingly, if an error occurs, the number of error data to be acquired by the firmware is large. However, because there is a limit to the capacity of the NVRAM, if the number of error data is large, all the data cannot be stored in the NVRAM. If all the data are not stored then it becomes difficult to specifying why the error has occurred.

In a background of the problem, there is a point that a resource that can be used by the firmware, such as a memory, is limited. In other words, because the firmware is a computer program running on a background of a work process that is to be primarily carried out by the server apparatus, it is desired that the firmware exhausts as little resources of the server apparatus as possible, and a process of the firmware be light at the same time. Because there is a limit to an operation of the firmware, it is necessary to carry out a writing process of the error data efficiently within a range of the limit imposed.

One approach is to compress the data by using a compression algorithm. The compression algorithm includes, for example, a run-length method and a Huffman method. However, because the resource that can be used by the firmware is limited, the firmware can not be used to carry out a complicated compression processing.

Although the firmware can make a request for compressing the error data to an application for the compression-processing running on the operating system, it is not desirable because the process becomes heavy if the compression processing is carried out via the operating system. Furthermore, when the operating system is not yet started, such as a time of starting the server apparatus, the request for the compression processing cannot be made.

According to the present invention, the firmware is made to carry out a compression processing of error data with a simple method, and write the compressed error data, as shown in FIG. 2, in a nonvolatile memory such as the NVRAM. First acquired error data is stored as an existing error, and whenever new error data is acquired, the new error data is compressed by taking a difference between the existing error stored and the new error data acquired, and the new error data compressed is written in the NVRAM. Even with this kind of simple compression processing, it is possible to obtain sufficient compression efficiency because there is a certain degree of typical property in the hardware error occurred in the server apparatus and the like.

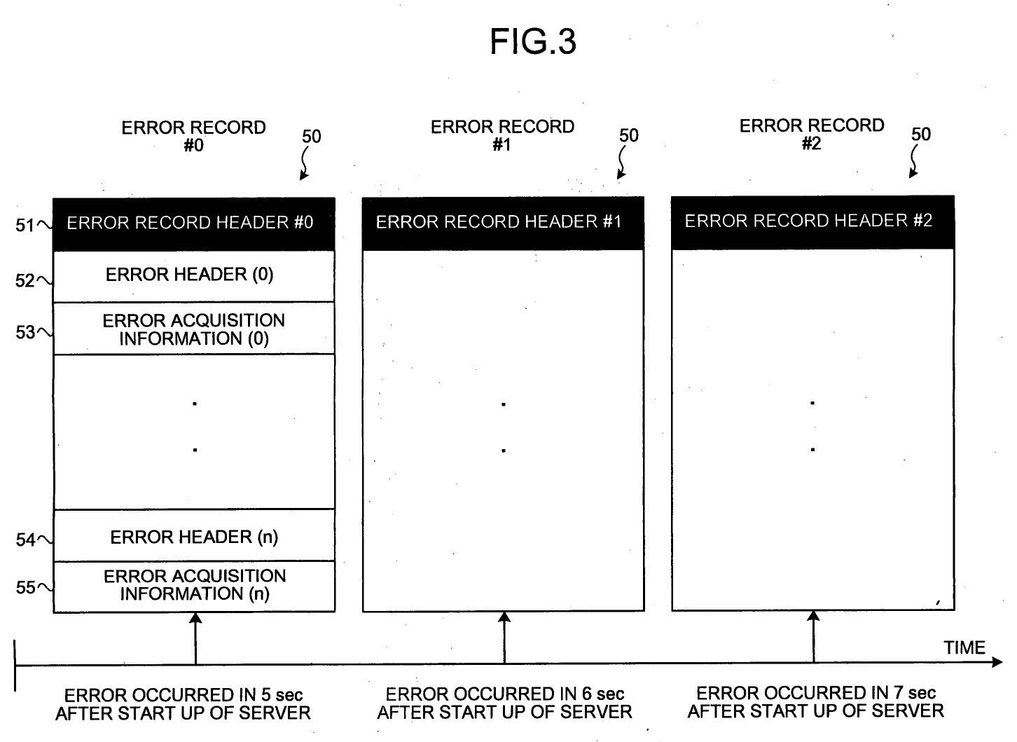

The typical property of the hardware errors that occur in the server apparatus is explained with reference to FIG. 3 to FIG. 5. FIG. 3 is a schematic diagram for explaining how hardware errors are acquired. A case is assumed that a hardware error has occurred immediately after the server apparatus had started.

As shown in FIG. 3, the firmware acquires the hardware error in a unit of an error record 50 that includes a plurality of pieces of error information. Each error record 50 includes an error record header 51 at the head thereof, followed by a total of n+1 number of pieces of error information starting from a set of an error header (0) 52, and then error-acquisition information (0) 53, and ending at a set of an error header (n) 54 and finally error-acquisition information (n) 55. The firmware acquires an error record whenever a hardware error occurs. In the case shown in FIG. 2, the firmware in 5 acquires error records #0, #1, and #2 in 5 seconds, 6 seconds, and 7 seconds after a start up of the server apparatus, respectively.

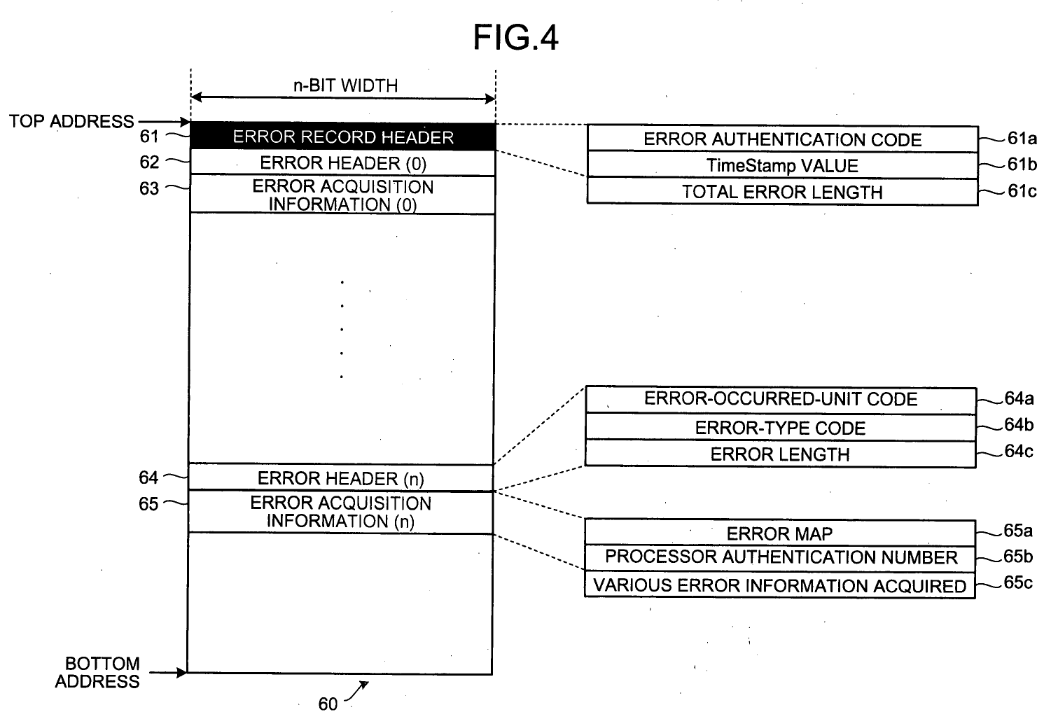

FIG. 3 is for explaining exemplary contents of the error record 50. All the error records are stored, for example, in a buffer of a RAM and the like. An error record header 61, an error header (0) 62, error-acquisition information (0) 63, an error header (n) 64, and error-acquisition information (n) 64 shown in FIG. 4 are equivalent to the error record header 51, the error header (0) 52, the error-acquisition information (0) 53, the error header (n) 54, and the error-acquisition information (n) 55 shown in FIG. 3, respectively.

The error record header 61 includes an error authentication code 61a, a TimeStamp value 61b, and a total error length. The error authentication code 61a is a code for identifying each of the errors, the TimeStamp value 61b is a value indicating a time when the error had occurred, and the total error length is a value indicating a total size of the error record 60.

The error header (n) 64 includes an error-occurred-unit code 64a indicating a hardware at which an error has occurred, an error-type code 64b indicating an error type such as a cache error and a bus error, and an error length 64c indicating a length obtained by adding the error header (n) 64 and the error-acquisition information (n) 65. The error-acquisition information (n) 65 includes an error map 65a indicating a specific unit at which an error has occurred, a processor authentication number 65b indicating a process at which an error has occurred, and various error information acquired 65c that is a main body of the error information.

In this manner, the error record 60 includes a plurality of hardware errors; however, a content of each of the hardware errors is not classified in detail. For example, when a parity error of a bus has occurred, a bit position of the parity error occurred is not included, but position information indicating a parity error occurred is related to an access to which hardware is included only. Therefore, even if there is a little difference in an error occurrence position, it is considered as the same hardware error.

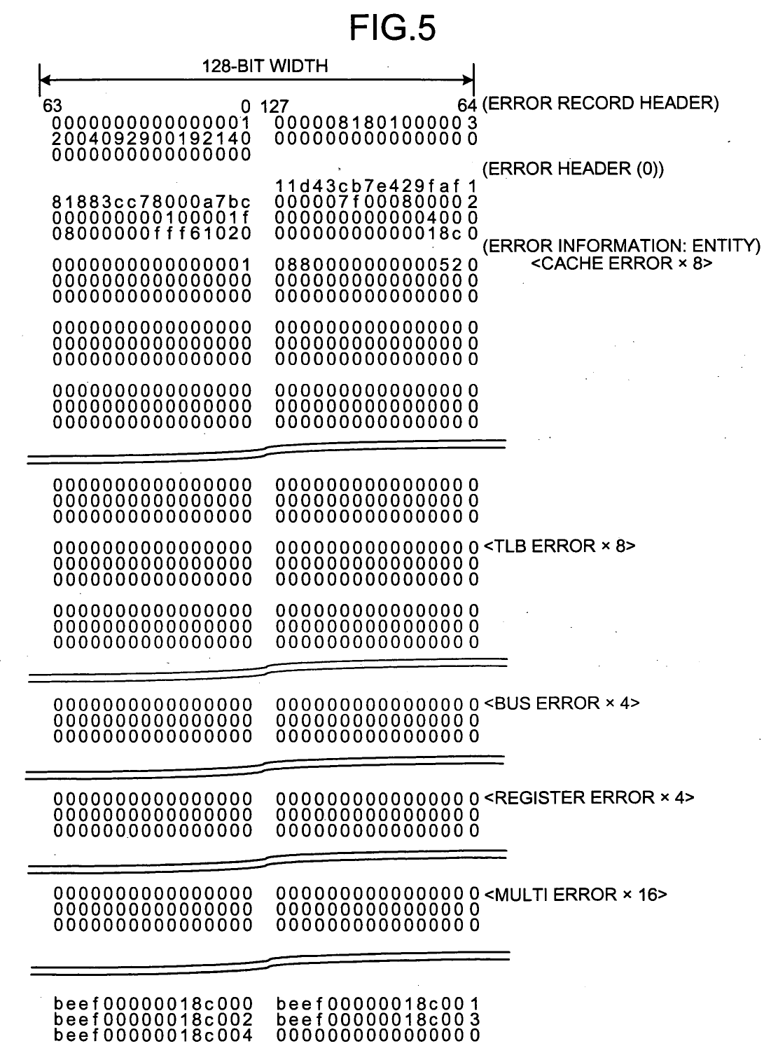

FIG. 5 is an example of contents of the error record 60. It is assumed that only a cache error has occurred. In this case, most parts of the error record 60 become “0”. The “0” shown in the figure is a hexadecimal number “0”.

Even when the error record 60 includes a large number of error data, if the error records 60 acquired in a row are compared, parts except for the TimeStamp 61b of the error record header 61 usually have the same value. because the reason being that the same hardware error occurs every time an access is made to a unit at which a hardware error has occurred, and as described above, the content of each of the hardware errors is not classified in detail, so that even if there is a little difference in an error occurrence position, it is considered to be the same hardware error.

Because there is a typical property in the hardware error occurred in the server apparatus, the method according to the present invention in which a compression process of the error data is carried out by taking a difference between the error records 60 is effective. Furthermore, although the difference between the error records 60 is taken in the present embodiment, the scheme is not limited to this. For example, any simple calculation in which a result of the calculation is apt to be “0” can be carried out, for example, an exclusive OR between the error records 60 also can be used.

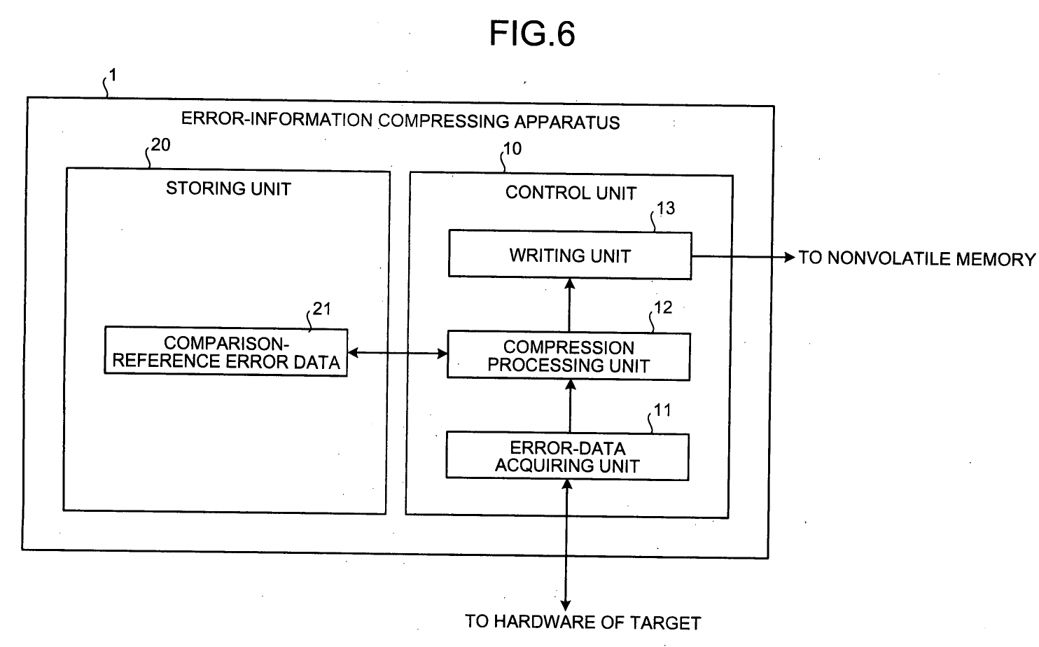

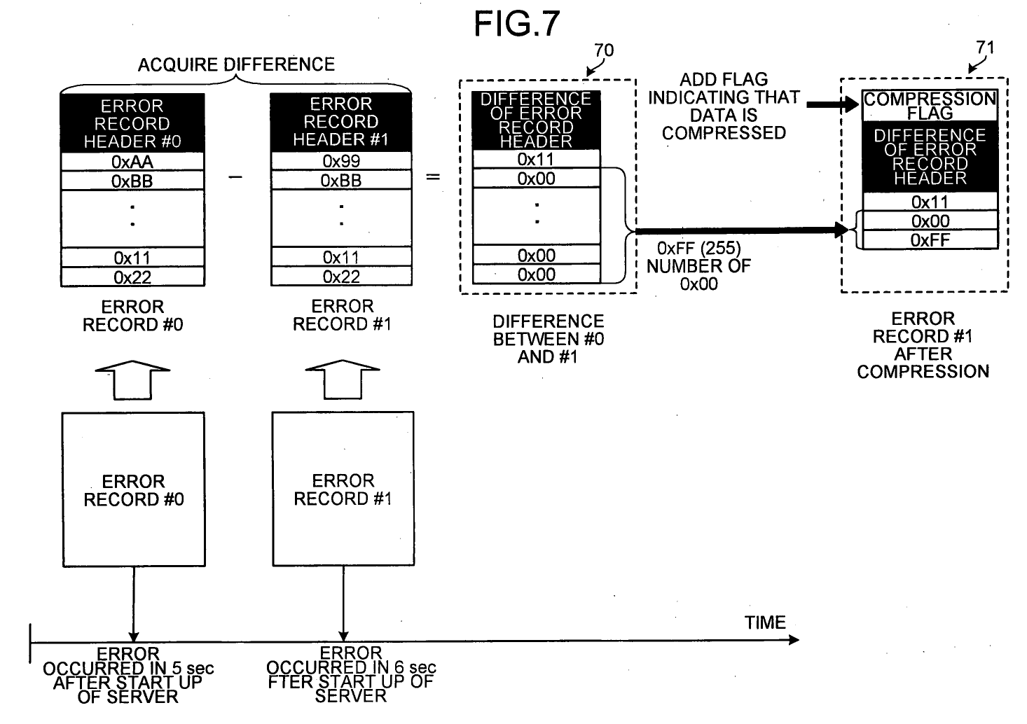

FIG. 6 is a functional block diagram of an error-information compressing apparatus 1 according to an aspect of the present invention. The error-information compressing apparatus 1 includes a control unit 10 and a storing unit 20. The control unit 10 includes an error-data acquiring unit 11, a compression processing unit 12, and a writing unit 13. The storing unit 20 stores therein comparison-reference error data 21.

The control unit 10 acquires error data from a hardware that is a target of an error collection, compresses the error data by taking a difference between the error data and the comparison-reference error data 21 stored in the storing unit 20, and writes the error data compressed in a nonvolatile memory via the writing unit 13. Furthermore, when a predetermined condition is satisfied, the control unit 10 substitutes the comparison-reference error data 21 with newly acquired error data.

The error-data acquiring unit 11, when a hardware error occurs, makes an access to the hardware that is the target of the error collection to detect a hardware error, acquires the error record 50, and delivers the error record 50 to the compression-processing unit 12.

The compression-processing unit 12 compresses the error record 50 received from the error-data acquiring unit 11, and delivers the compressed error record 50 to the registering unit 13. The compression-processing unit 12 compresses the error record 50 by taking a difference between the error record 50 received and the comparison-reference error data 21 stored in the storing unit 20, and when a part of a predetermined unit, such as 1 byte (8 bits) and 8 bytes (64 bits), is “0”, substituting the part of “0″” with data including continuous number of “0”. Furthermore, when a volume of the compressed data is greater than that before the compression, and when the compression-processing unit 12 receives the first error record 50, the compression-processing unit 12 delivers the error record 50 before the compression to the registering unit 13.

The compression-processing unit 12 also carries out an initial registration and substitution of the comparison-reference error data 21. Upon receiving the first error record 50, the compression-processing unit 12 stores the data in the storing unit 20 as the comparison-reference error data 21. After that, every time the error record 50 is received, the compression-processing unit 12 carries out the compression processing by comparing the error record 50 received with the comparison-reference error data 21. When a size of the error record 50 after the compression is greater than that before the compression, the compression-processing unit 12 substitutes the comparison-reference error data 21 stored in the storing unit 20 with the error record 50 before the compression.

When the size of the error record 50 after the compression is greater than that before the compression, it means that a tendency of the hardware error has changed, such as a case in which a different hardware error has been detected. Because a hardware error of the similar tendency is generally detected after the tendency of the hardware error has changed, a method of substituting the comparison-reference error data 21 by comparing a size before and after the compression is simple and effective way of carrying out an efficient compression processing.

FIG. 6 is a schematic diagram for explaining an outline of the compression processing. The compression-processing unit 12 receives an error record #0 as the first error record from the error-data acquiring unit 11, and stores the error record #0 in the storing unit 20 as the comparison-reference error data 21. When the compression-processing unit 12 receives an error record #1, the compression-processing unit 12 carries out a process of subtracting the newly received error record #1 from the comparison-reference error data 21 (error record #0) for every predetermined unit. In the example shown in the figure, the unit of a subtraction processing is 1 byte (8 bits), an error record of 256 bytes except for a header is illustrated.

A difference data 70 generated in this manner becomes data in which 0×00 (all the 8 bits is “0”) is continued. In the example shown in the figure, 255 (0×FF) number of 0×00 is continued, a compression data 71 becomes the one shown in the figure. In other words, 255 bytes of continuous “0” is substituted with 1 byte of “0” and 1 byte of numerical value. Furthermore, a predetermined compression flag is added in front of the difference of the error record header, which indicates that the data is compressed.

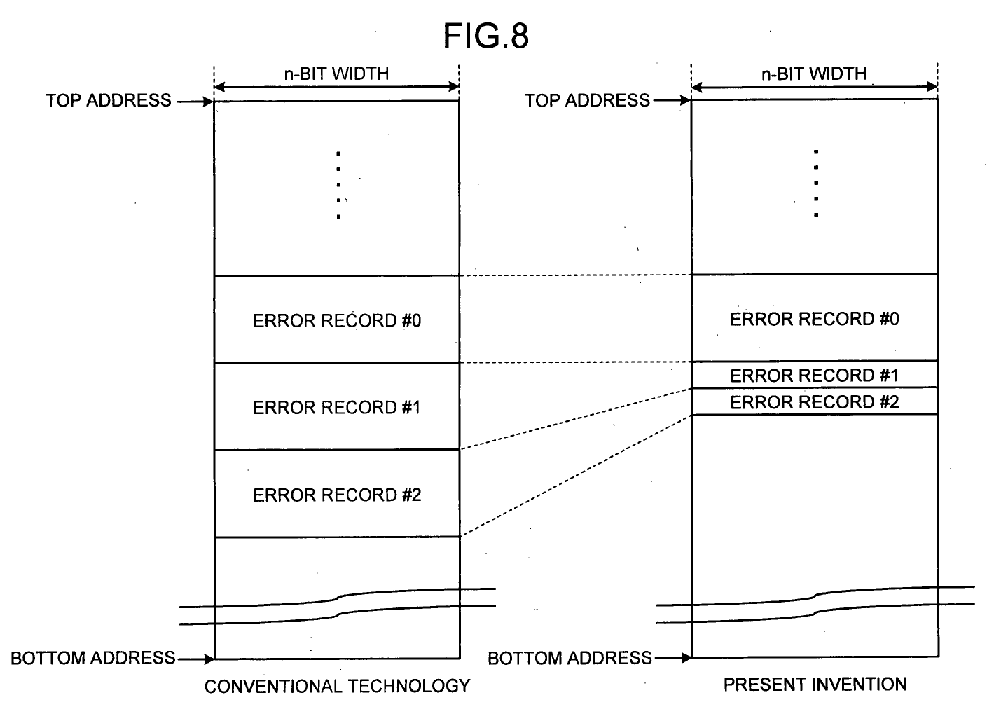

Referring back to FIG. 6, the writing unit 13 receives the error record 50 before or after the compression from the compression-processing unit 12, and writes (registers) the data in a nonvolatile memory such as an NVRAM. FIG. 8 is an exemplary error record that is stored in the nonvolatile memory.

As shown in FIG. 8, according to the conventional technology, the error records acquired (#0 to #2) are stored in the nonvolatile memory without compressing. On the other hand, in the present invention, when the error record #0 is acquired as the comparison-reference error data 21, the error record #0 is registered as it is in the nonvolatile memory; and the-error record #1 and the error record #2 are compressed and written in the nonvolatile memory. Therefore, it is possible to reduce an amount of data stored in the nonvolatile memory of which the storing capacity is generally limited. Furthermore, because the data after the compression is stored, it is possible to suppress a time required for the storing process and a process load to a bus and the like. The top address and the bottom address shown in FIG. 8 define a storage area of the nonvolatile memory.

Referring to FIG. 6, the storing unit 20 is a RAM or the like and it is used as a buffer. A part of a main memory of the server apparatus can be used effectively as the storing unit 20. The comparison-reference error data 21 is the error record 50 that becomes a reference for the compression processing by taking a difference, and as described above, an initial registration and a substitution of the comparison-reference error data 21 are carried out by the compression-processing unit 12. The error record 60 shown in FIG. 4 indicates the error record 50 in a state of being stored in the storing unit 20, and the top address and the bottom address shown in FIG. 4 define a storage area that is used by the firmware as a buffer.

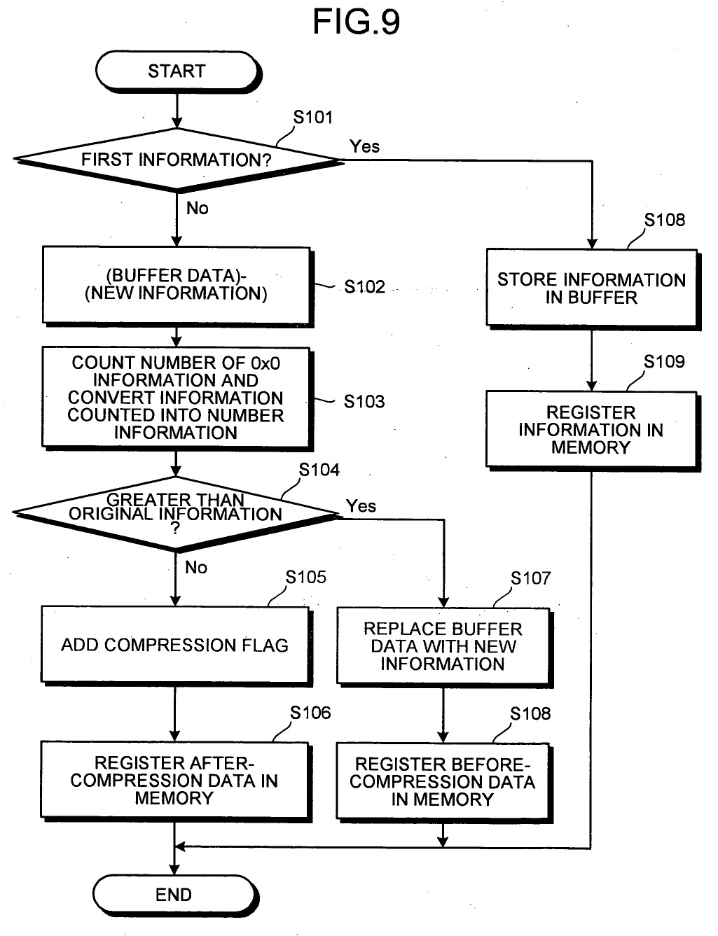

FIG. 9 is a flowchart of a process procedure for the error-information compression processing. The error-data acquiring unit 11 acquires an error record 50 from a hardware of the target and delivers the error record 50 to the compression-processing unit 12. Then, the compression-processing unit 12 determines whether the error record 50 received is the first error information (step S101).

When the error record 50 received is the first error information (YES at step S101), the compression-processing unit 12 stores the error record 50 in the storing unit 20 as the comparison-reference error data 21 (step S108), and delivers the error record 50 to the registering unit 13 (step S109) for writing in the nonvolatile memory.

On the other hand, when the error record 50 received by the compression-processing unit 12 is not the first error information (NO at step S101), the compression-processing unit 12 calculates a difference between the comparison-reference error data 21 stored in the storing unit 20 and the error record 50 (step S102), and substitutes a part of data having continuous “0” with a value indicating number of continuous “0” by counting number of predetermined unit of data having “0” (step S103) to compress the data. For example, when a difference data is divided in 1 byte unit, if 255 bytes of 0×00 is continued, the 255 bytes of data is substituted with 2 bytes of 0×00 and 0×FF (255 in decimal number).

After that, the compression-processing unit 12 determines whether a size of the error record 50 after a compression processing is greater than that before the compression processing (step S104). When the size is greater (YES step S104), the compression-processing unit 12 substitutes the comparison-reference error data 21 stored in the storing unit 20 with the error record 50 before the compression processing (step S107), and delivers the error record 50 before the compression processing to the writing unit for writing in the nonvolatile memory (step S108).

On the other hand, when the size is not greater (NO at step S104), the compression-processing unit 12 adds a compression flag to the error record 50 after the compression processing (step S105). Then, the compression-processing unit 12 delivers the error record 50 after the compression processing to which the compression flag is added to the writing unit for writing in the nonvolatile memory (step S 106).

As describe above, according to the present embodiment, an error-data acquiring unit acquires an error record from a hardware of a target of an error collection, and delivers the error record acquired to a compression-processing unit. The compression-processing unit calculates a difference between a comparison-reference error data stored in a storing unit and the error record received to compress the error record. When a size of the error record after compression is greater than that before the compression, the comparison-reference error data is substituted with the error record before the compression, and the error record before the compression is stored in a nonvolatile memory. Otherwise, the error record after the compression is registered in the nonvolatile memory. Therefore, it is possible to carry out compression and storage of error information speedily and with a simple mechanism.

Although, the present invention is applied to an error-information compressing apparatus, the present invention is not limited to the present embodiment. For example, the present invention can also be applied for collecting and storing error information in a computer such as a server apparatus.

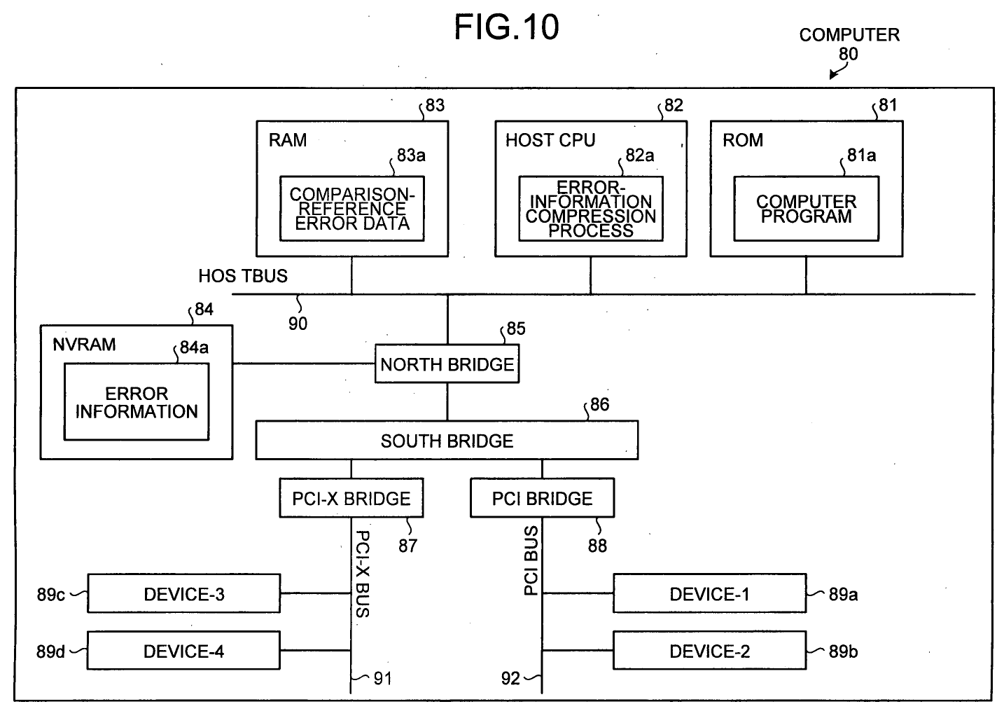

The various kinds of processing explained in the present embodiment can be implemented by executing a program prepared in advance on a computer. FIG. 10 is a schematic diagram of a computer 80 that executes a computer program to implement the various kinds of processing.

The computer 80 includes a read only memory (ROM) 81, a host CPU 82, a RAM 83, and a north bridge 85 connected by a host bus 90, an NVRAM 84 and a south bridge 86 connected to the north bridge 85, and a PCI-X bridge 87 and a PCI bridge 88 connected to the south bridge 86. Furthermore, various devices (89a to 89d) are connected to the PCI-X bridge 87 and the PCI bridge 88 via a PCI-X bus 91 and a PCI bus 92, respectively.

The RAM 83 is equivalent to the storing unit 20 shown in FIG. 6, and the NVRAM 84 is equivalent to the nonvolatile memory provided outside of the error-information compressing apparatus 1 shown in FIG. 6. Various types of buses and devices shown in FIG. 10 are equivalent to the hardware of the target that are located outside of the error-information compressing apparatus 1 shown in FIG. 6.

A computer program 81a that implements the compression processing is stored in the ROM 81 in advance. When starting the computer, the Host CPU 82 reads the computer program 81a from the ROM 81, and executes the computer program 81a, which causes the computer program 81a function as an error-information compressing process 82a. When the error-information compressing process 82a is started, a comparison-reference error data 83a is stored in the RAM 83, and an error data after a compression processing is registered in the NVRAM 84 to be accumulated as error information 84a.

According to the present invention, a reference value is used for determining whether to compress acquired error data, and if it is determined that the acquired error data is to be compressed, the acquired is compressed are then stored in a storage device. If the error data are acquired one after the other, then the first error data can be used as the reference value. Therefore, it is possible to compress and store error information speedily and with a simple mechanism.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An error-information compressing apparatus comprising:
an acquiring unit that acquires a hardware error from a hardware;
a storing unit that stores therein reference data;
a compressing unit that compresses the hardware error by using the reference data into compressed hardware error; and
a writing unit that writes the compressed hardware error in a storage device.

2. The error-information compressing apparatus according to claim 1, wherein the compressing unit calculates a difference between the hardware error and the reference data every predetermined unit, and when the predetermined unit having a difference of zero continues, substitutes the predetermined unit with data including number of continuation of zero difference.

3. The error-information compressing apparatus according to claim 1, wherein the acquiring unit acquires a plurality of the hardware errors one after another, and the storing unit stores therein the hardware error that is first acquired by the acquiring unit as the reference data.

4. The error-information compressing apparatus according to claim 1, wherein when a volume of the compressed hardware error is greater than a volume of the hardware error, the storing unit substitutes existing reference data with the compressed hardware error.

5. The error-information compressing apparatus according to claim 1, wherein the acquiring unit acquires a plurality of the hardware errors.

6. An error-information compressing method comprising:
compressing a hardware error acquired from a hardware by using reference data into compressed hardware error; and
writing the compressed hardware error in a storage-device.

7. The error-information compressing method according to claim 6, wherein the compressing includes
calculating a difference between the hardware error and the reference data every predetermined unit, and when the predetermined unit having a difference of zero continues, substituting the predetermined unit with data including number of continuation of zero difference.

8. The error-information compressing method according to claim 6, wherein a plurality of the hardware errors are acquired one after another, and the hardware error that is first acquired is taken as the reference data.

9. A computer-readable recording medium that stores therein a computer program that causes a computer to execute:
compressing a hardware error acquired from a hardware by using reference data into compressed hardware error; and
writing the compressed hardware error in a storage device.

10. The computer-readable recording medium according to claim 9, wherein the compressing includes
calculating a difference between the hardware error and the reference data every predetermined unit, and when the predetermined unit having a difference of zero continues, substituting the predetermined unit with data including number of continuation of zero difference.

11. The computer-readable recording medium according to claim 9, wherein a plurality of the hardware errors are acquired one after another, and the hardware error that is first acquired is taken as the reference data.
